(19) United States
(12) Patent Application Publication
(10) Pub. No.: US 2010/0083255 A1
(43) Pub. Date: Apr. 1, 2010

(54) NOTIFICATION BATCHING BASED ON USER STATE

(75) Inventors: Ryan Howard Bane, Redmond, WA (US); Jon ChangZheng Xu, Seattle, WA (US); Oliver Bruno Colbert, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/239,241

(22) Filed: Sep. 26, 2008

(51) Int. Cl. G06F 9/46

(52) U.S. Cl. 718/101

(57) ABSTRACT

Batching messages such as notifications intended for a user to preserve battery life on a computing device associated with the user. A server such as a proxy server receives the messages from one or more service providers. The proxy server maintains a state of the user. If the state indicates that the user is idle, the messages are stored at the proxy server unless the messages correspond to activating messages. The activating messages are sent to the user upon receipt. The stored messages are sent when the state changes to an active state or when a defined duration of time elapses. In some embodiments, the messages are presence notifications in an instant messaging session on a mobile computing device. By reducing the frequency of sent notifications, the battery life of the mobile computing device is preserved.

### BACKGROUND

Most mobile computing devices use a cellular radio for communication. After the radio powers on to send data, the radio takes several seconds to power off (e.g., about 3 seconds on 2.5G networks and about 20 seconds on 3G networks). This radio “tail” absorbs power and diminishes battery life on the mobile computing device. Further, there are other power inefficiencies in repeatedly spinning up the radio and shutting down the radio.

Connected applications with real-time data push or updates are being widely adopted by mobile users. The applications include instant messaging, electronic mail, personal information management, presence information, and other web applications. The servers push the data in an uncoordinated manner such that battery life on the mobile computing device degrades, negatively affecting the user experience. For example, existing proxy servers immediately send any messages received from service partners or providers to the mobile devices. The radio on the mobile computing device is powered on more often, or remains powered on longer, thus draining the battery faster.

### SUMMARY

Embodiments of the invention batch messages intended for a user to preserve battery life of a computing device associated with the user. A proxy server receives the messages from a service provider. A state of the user is determined. If the user is in the idle state and none of the messages are activating messages, the messages are stored for future delivery when the state changes or when a defined time period elapses. If any of the messages are activating messages, the messages are transmitted to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating messages being sent from service providers to a mobile computing device.

FIG. 2 is an exemplary block diagram illustrating a proxy server storing computer-executable components for batching messages.

FIG. 3 is an exemplary flow chart illustrating identification and delivery of an activating message.

FIG. 4 is an exemplary sequence diagram illustrating radio wakeups on a mobile computing device.

FIG. 5 is an exemplary sequence diagram illustrating activity tracking within the proxy server.

FIG. 6 is an exemplary sequence diagram illustrating operation of a batch timer for sending batches of messages to the user.

FIG. 7 is an exemplary sequence diagram illustrating operation of an inactivity timer for setting a state of the user.

Corresponding reference characters indicate corresponding parts throughout the drawings.

### DETAILED DESCRIPTION

Referring to the figures, embodiments of the invention implement server-side batching of notifications or messages (e.g., low priority) to a computing device (e.g., a mobile computing device 102) of a user upon detection of a user idle state. The idle state represents a period of inactivity by the user. For the duration of inactivity, the user receives notifications, presence updates, or other messages in batches sent at defined intervals. The active state represents a period of direct user activity (e.g., the user interacting with the computing device). For the duration of activity, the notifications are sent from the server to the user immediately upon receipt of the notifications by the server. Activating messages such as high priority notifications or explicit user actions take the user out of the idle state into the active state. Further, in an instant messaging embodiment, online and offline transitions are treated as non-batchable to ensure that the mobile computing device 102 has a more accurate, updated view of the status of online friends or buddies.

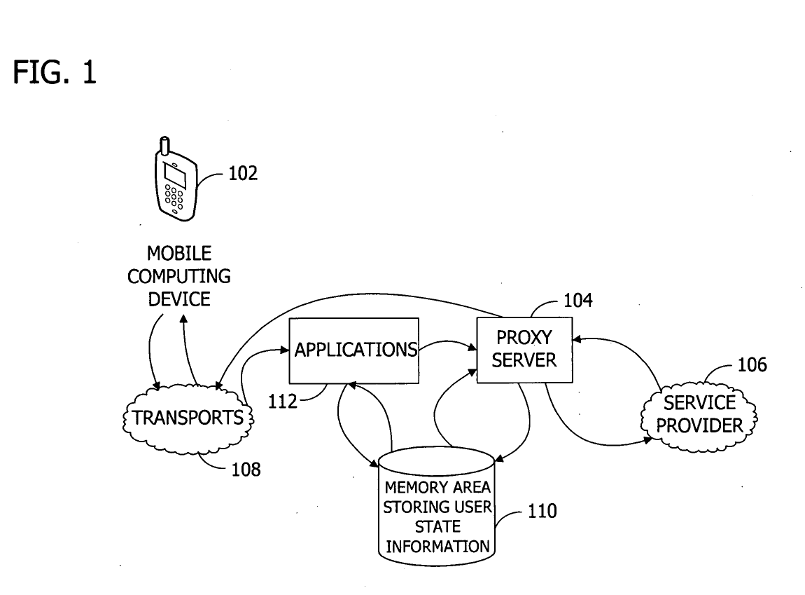

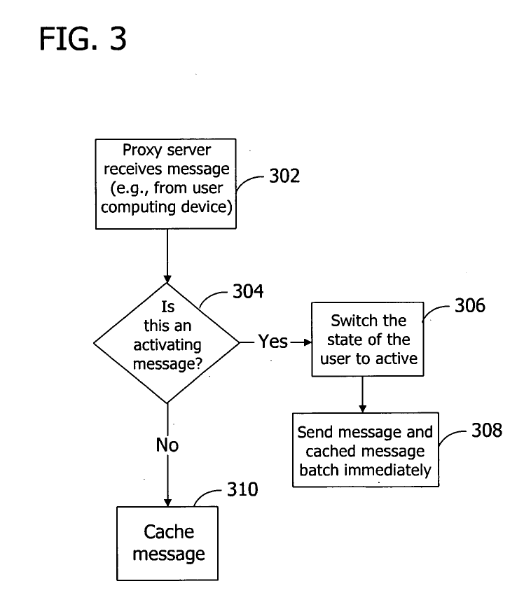

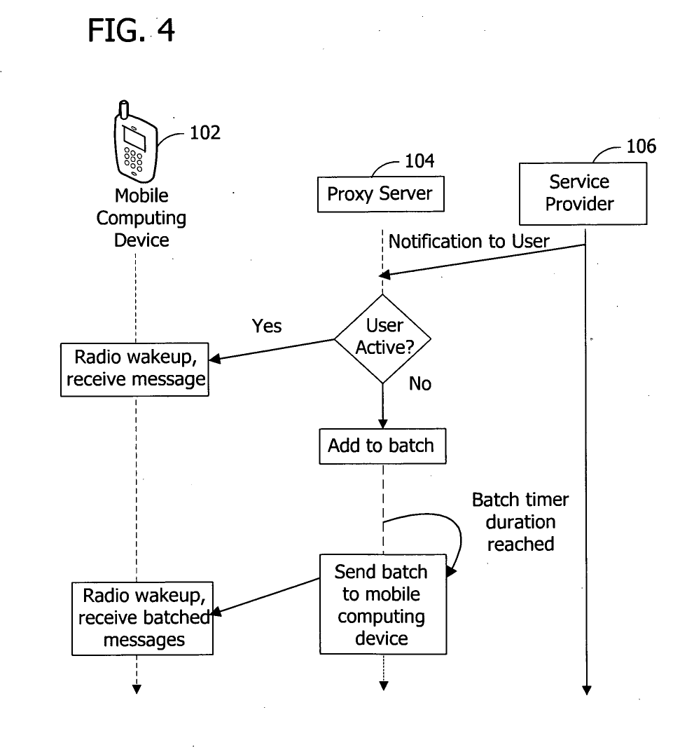

Referring again to FIG. 1, an exemplary block diagram illustrates messages being sent from one or more service providers 106 to the mobile computing device 102. The messages include invite requests, message requests, friend or buddy requests, synchronization of contacts, presence updates, and other operations. The service provider 106, service partner, or other entity sends the messages for the user to a proxy server 104 or other server or computing device. The proxy server 104 accesses state information 208 about the user stored in a memory area 110. The state information 208 represents an activity state or presence state of the user. Depending on the state of the user as described with reference to FIG. 3 and FIG. 4 below, the proxy server 104 caches or deliver (e.g., via transports 108) the messages. Applications 112 associated with the mobile computing device 102 update the proxy server 104 on the activity or inactivity of the user.

While aspects of the invention are described with reference to the computing device of the user being the mobile computing device 102, embodiments of the invention are operable with any device associated with the user. For example, aspects of the invention are operable with devices such as laptop computers, gaming consoles, hand-held or vehicle-mounted navigation devices, portable music players, and other devices.

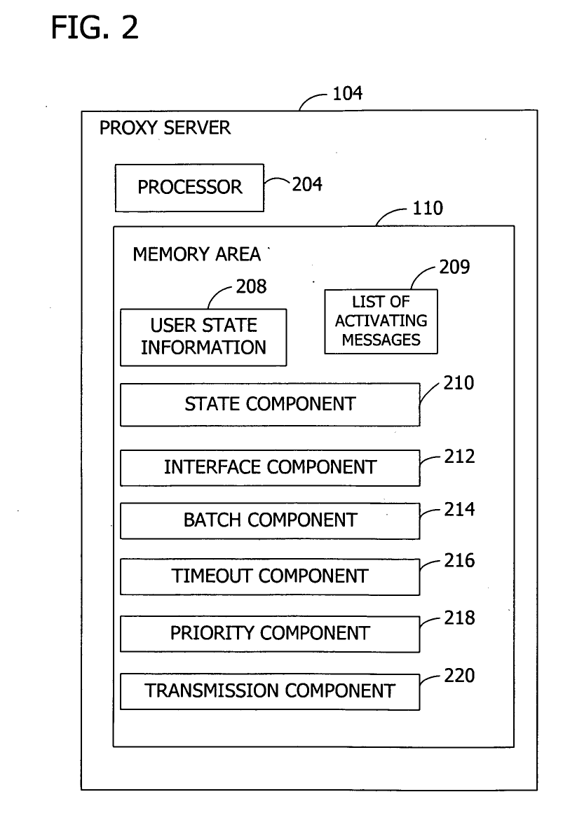

Referring next to FIG. 2, an exemplary block diagram illustrates the proxy server 104 storing the state of the user or a plurality of users. The computing device includes a processor 204 and the memory area 110, or other computer-readable media. The memory area 110 stores a list of one or more of the activating messages. The activating messages may be divided into the following exemplary categories: user initiated messaging, user initiated contacts, user initiated profile actions, proxy server initiated messaging, and messaging notification. Appendix A describes exemplary activating messages.

The memory area 110 also stores one or more computer-executable components such as a state component 210, an interface component 212, a batch component 214, a timeout component 216, a priority component 218, and a transmission component 220. The state component 210 maintains the state of the user on the computing device. The interface component 212 executes on the proxy server 104 to receive one or more of the messages intended for the user from at least one of the service providers 106. The batch component 214 stores the messages received by the interface component 212. The timeout component 216 maintains a batch timer. The batch timer represents a duration of time elapsed since a previous communication with the computing device. In some embodiments, the duration is thirty minutes. The priority component 218 compares the messages received by the interface component 212 to a list of activating messages to determine whether the received messages correspond to one of the activating messages. The transmission component 220 sends the messages stored by the batch component 214 based on the state of the user maintained by the state component 210, the batch timer maintained by the timeout component 216, and the comparison performed by the priority component 218.

In some embodiments, the transmission component 220 sends the messages when a value associated with the batch timer exceeds a defined value. The timeout component 216 resets the batch timer after the transmission component 220 sends the messages. The transmission component 220 sends the messages when at least one of the received messages matches a message from the list of activating messages.

The interface component 212 may also receive a message form the user, where the message corresponds to one of the activating messages. In response, the state component 210 adjusts the state of the user to the active state. The transmission component 220 then sends any batched messages to the user responsive to the adjustment to the active state. Further, any subsequently received messages are sent immediately to the user while the user is in the active state. The message corresponding to one of the activating messages includes, for example, a notification of a change in the state of the user, or any of the exemplary activating messages described in Appendix A.

In some embodiments, the proxy server 104 batches presence notifications based on user state during an instant messaging session on the mobile computing device 102. In such embodiments, the memory area 110 further stores a presence state of a user. The presence state corresponds to an idle state or an active state.

Referring next to FIG. 3, an exemplary flow chart illustrates identification and delivery of an activating message. At 302, the proxy server 104 receives one or more of the messages from the service provider 106. If the messages correspond to one of the activating messages on the list of activating messages at 304, the state of the user is switched to the active state at 306 and the messages are sent to the computing device of the user at 308. In some embodiments, only the received message corresponding to one of the activating messages is sent at 308. In other embodiments, all messages stored at the proxy server 104 are delivered at 308.

If none of the messages corresponds to any of the activating messages at 304, the received messages are cached at 310. In some embodiments, the received messages supersede or update one or more of the messages already cached for delivery by the proxy server 104. For example, the received messages include presence notifications that update presence information sent previously to the proxy server 104 (e.g., outdated presence notifications).

Referring next to FIG. 4, an exemplary sequence diagram illustrates radio wakeups on the mobile computing device 102. The service provider 106 sends notifications to the proxy server 104 for delivery to the mobile computing device 102. If the user is in the active state, the notifications are sent to the mobile computing device 102. This results in a radio wakeup on the mobile computing device 102 if the radio is not powered on. If the user is in the idle state, the notifications are stored, batched, or added to any other notifications stored on the proxy server 104.

When the batch timer expires, a defined duration of time elapses, or other threshold has been exceeded, the batched messages are sent to the mobile computing device 102. The batch timer measures a duration of time that has elapsed since the last transmission of messages to the mobile computing device 102. The duration of time is compared to a predefined time threshold to determine whether to send the batched messages.

Sending the batched messages to the mobile computing device 102 results in a radio wakeup on the mobile computing device 102 if the radio is not powered on. In some embodiments, the state of the user remains in the idle state after delivery of the batched messages. In other embodiments, the state of the user changes to the active state, indicating that the radio is available for a period of time. The active state is maintained for a period of time, and then changed back to the idle state if there has been no activity by the user.

In some embodiments, the operations illustrated in FIG. 3 and FIG. 4 are combined. For example, after determining that the state of the user corresponds to the idle state, the messages received by the proxy server 104 are compared to the list of activating messages. If any of the received messages match any of the activating messages, the determined state of the user is overridden and the received messages are sent to the mobile computing device 102.

In an instant messaging embodiment, the proxy server 104 receives presence notifications from the service provider 106. The proxy server 104 determines the presence state of the user (e.g., active, idle, away from desk, etc.). The proxy server 104 stores the received presence notifications in the memory area 110 based on the accessed presence state to prevent transmission of the presence notifications to the user when the presence state corresponds to the idle state.

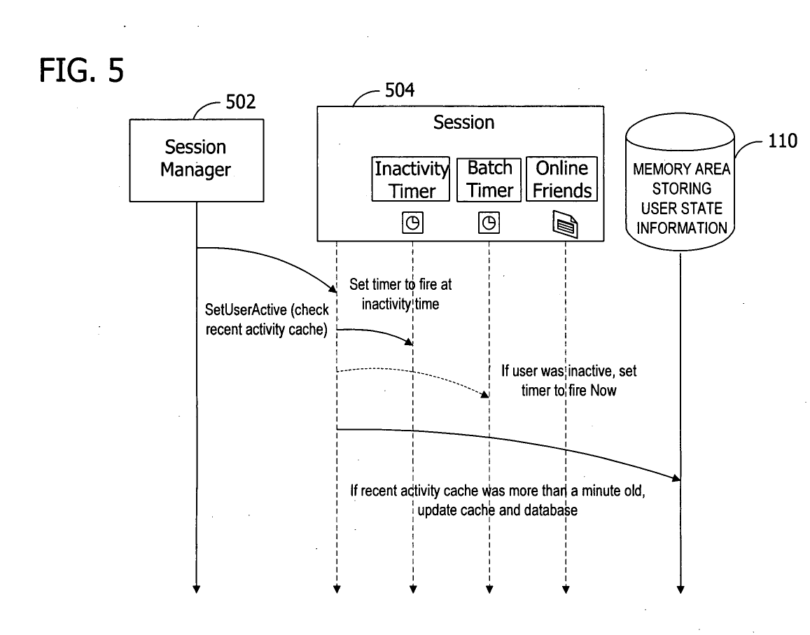

Referring next to FIG. 5, an exemplary sequence diagram illustrates activity tracking within the proxy server 104. The proxy server 104 maintains a batch timer and an inactivity timer for each session 504 with the mobile computing device 102 (e.g., an instant messaging session or other session 504). A session manager 502 (e.g., detecting traffic to and from the mobile computing device 102) updates the proxy server 104 on the activity or inactivity of the user. The inactivity timer measures the length of time the proxy server 104 is configured to wait before switching the user between the active state and the inactive state. In some embodiments, the length of time is one hour. For example, the proxy server 104 stores a LastActivityTime entry in a database. The LastActivityTime value is used to determine whether the inactivity timer should expire or trigger the change in state.

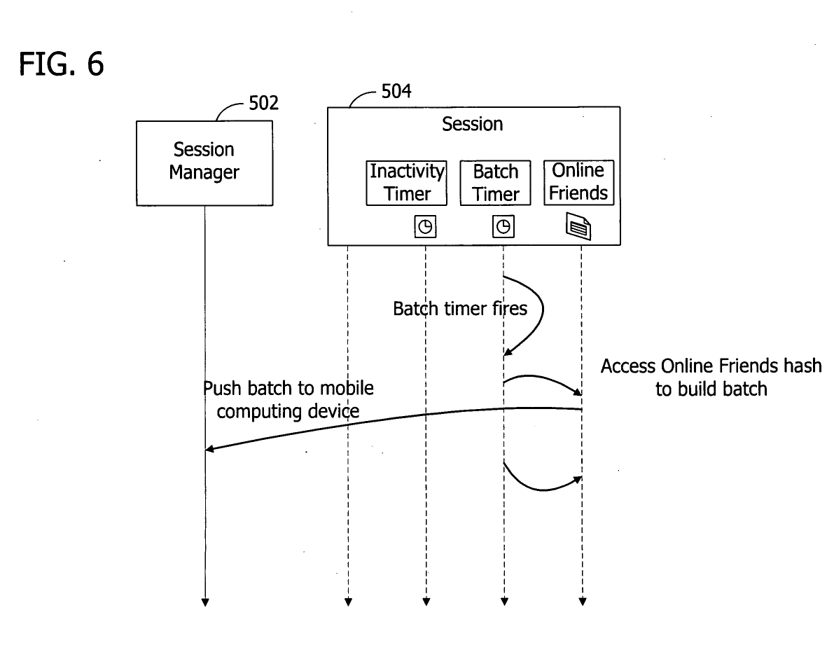

Referring next to FIG. 6, an exemplary sequence diagram illustrates operation of the batch timer for sending batches of messages to the user. When the state of the user switches to the inactive state, the batch timer is configured to fire at the batch frequency (e.g., every thirty minutes of inactivity). When activity is detected and the state of the user changes to the active state, the batch timer fires immediately to send out any batched messages. The batch timer is then disabled until the user switches back to the inactive state.

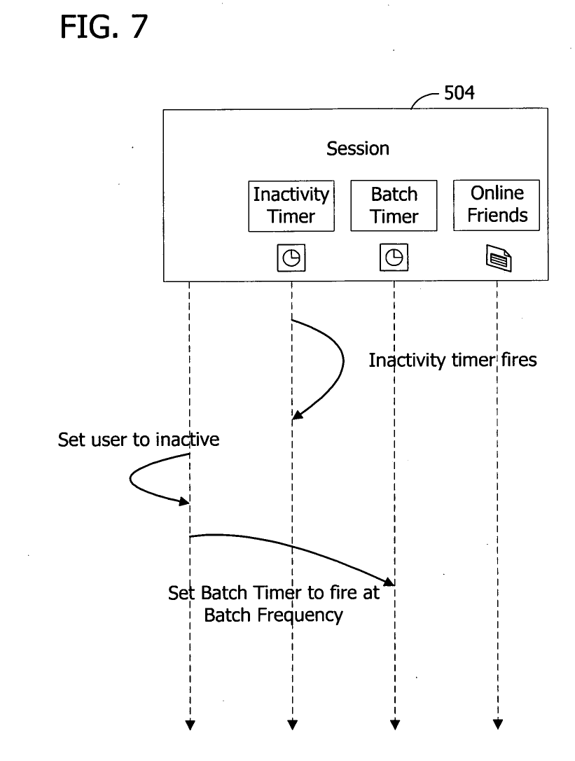

Referring next to FIG. 7, an exemplary sequence diagram illustrates operation of the inactivity timer for setting a state of the user. When the inactivity timer fires, the state of the user is set to the inactive state. The batch timer is also set or enabled (see FIG. 6).

### Exemplary Operating Environment

By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The embodiments illustrated and described herein as well as embodiments not specifically described herein but within the scope of aspects of the invention constitute exemplary means for batching the presence notifications while the user is idle to preserve battery life on the mobile computing device 102, and exemplary means for maintaining the presence state of the user based on the inactivity timer.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

A list of exemplary activating messages is shown below.

| Category | Action | Description |
|---|---|---|
| Client Initiated | Invite | Invites a contact to a new conversation. |
| Messaging | | |
| | Refer | Refers a contact to an existing conversation. |
| | Message | Sends a message to the participants in a conversation. |
| | ObjectTransferInvite | Requests permission to send an object. |
| | ObjectTransfer | Transfers an object. |
| | ObjectTransferCancel | Cancels an object transfer. |
| | Bye | Removes the user from a conversation. |
| Client Initiated | Create | Creates a contact. |
| Contacts | | |
| | Put | Modifies a contact. |
| | Delete | Deletes a contact. |
| | Get | Gets a contact's UserTile. |
| | Rolemap Update | Add or modifies one or more e-mail |
| | | addresses in the rolemap list. |
| Client Initiated | Put | Modifies the user's profile information. |
| Profile Actions | | |
| Server Initiated | Invite | Notifies the client of an invitation to a |
| Messaging | | conversation. |
| | Refer | Notifies the client of a referral to an existing |
| | | conversation. |
| | Message | Notifies the client of a message from a |
| | | conversation. |
| | ObjectTransferInvite | Notifies the client of an invitation to |
| | | receive a binary object. |
| | ObjectTransfer | Notifies the client of an object transfer |
| | | from a conversation. |
| | ObjectTransferCancel | Notifies the client that an object transfer |
| | | has been canceled. |
| | Bye | Notifies the client that a participant has |
| | | left a conversation. |
| Messaging | Call | New attendee joins conversation by |
| Notification | | referral from another participant |
| | Subscription | A person not in the user's contact list has |
| | | requested to become a contact. |

What is claimed is:

1. A system for batching presence notifications based on user state during an instant messaging session on a mobile computing device, said system comprising:
a memory area for storing a presence state of a user, said presence state corresponding to an idle state or an active state, said memory area being associated with a proxy server; and
a processor programmed to:
determining the presence state of the user based on an inactivity timer, said inactivity timer measuring a duration of time during which the user is idle on the mobile computing device;
storing the determined presence state in the memory area;
receiving, by the proxy server, one or more presence notifications from at least one service provider intended for a user;
accessing the presence state stored in the memory area;
storing the received presence notifications in the memory area based on the accessed presence state to prevent transmission of the presence notifications to the user when the presence state corresponds to the idle state; and
sending the received presence notifications to the user when the presence state corresponds to the active state.

2. The system of claim 1, wherein the processor is further programmed to set the presence state to the idle state when the duration of time exceeds a defined threshold value.

3. The system of claim 1, wherein the processor is further programmed to:
receive an activating message from the user; and
set the presence state to the active state responsive to the received activating message.

4. The system of claim 1, further comprising means for batching the presence notifications while the user is idle to preserve battery life on the mobile computing device.

5. The system of claim 1, further comprising means for maintaining the presence state of the user based on the inactivity timer.

6. A method comprising:
receiving, by a proxy server, one or more messages from at least one service provider intended for a user;
determining a state of the user on a computing device associated with the user, said determined state corresponding to an idle state or an active state;
if the determined state corresponds to the idle state:
comparing the received messages to a list of activating messages;
storing the received messages in a memory area associated with the proxy server if none of the received messages appear on the list of activating messages; and
sending the received messages to the user if at least one of the received messages appears on the list of activating messages; and
if the determined state corresponds to the active state, sending the received messages to the user.

7. The method of claim 6, wherein the determined state corresponds to the idle state, and further comprising:
determining a duration of the idle state;
comparing the determined duration to a predefined time threshold;
sending the messages stored in the memory area when the determined duration exceeds the predefined time threshold based on said comparing.

8. The method of claim 6, further comprising:
receiving notification of a change in the state of the user from the idle state to the active state; and
sending the messages stored in the memory area responsive to the received notification.

9. The method of claim 6, wherein receiving the one or more messages comprises receiving a presence notification associated with another user.

10. The method of claim 6, wherein comparing the received messages to the list of activating messages comprises comparing the received messages to one or more of the following categories: user initiated messaging, user initiated contacts, user initiated profile actions, proxy server initiated messaging, and messaging notification.

11. The method of claim 6, further comprising maintaining the active state of the user for a defined duration of time subsequent to sending the messages stored in the memory area.

12. The method of claim 11, further comprising adjusting the determined state of the user to the idle state after the duration of time has elapsed.

13. The method of claim 6, further comprising updating the messages stored in the memory area with the received messages.

14. The method of claim 13, wherein the received messages correspond to presence notifications, and wherein updating the messages comprises replacing outdated presence notifications.

15. One or more computer-readable media having computer-executable components, said components comprising:
a state component for maintaining a state of a user on a computing device, said state corresponding to an idle state or an active state;
an interface component for receiving, by a proxy server, one or more messages intended for a user from at least one service provider;
a batch component for storing the messages received by the interface component;
a timeout component for maintaining a batch timer, said batch timer representing a duration of time elapsed since a previous communication with the computing device;
a priority component for comparing the messages received by the interface component to a list of activating messages; and
a transmission component for sending the messages stored by the batch component based on the state of the user maintained by the state component, the batch timer maintained by the timeout component, and the comparison performed by the priority component.

16. The computer-readable media of claim 15, wherein the transmission component sends the messages when a value associated with the batch timer exceeds a defined value.

17. The computer-readable media of claim 16, wherein the timeout component resets the batch timer after the transmission component sends the messages.

18. The computer-readable media of claim 15, wherein the transmission component sends the messages when at least one of the received messages matches a message from the list of activating messages.

19. The computer-readable media of claim 15, wherein the priority component determines whether the received messages correspond to one of the activating messages.

20. The computer-readable media of claim 15, wherein the interface component receives, from the user, a message corresponding to one of the activating messages, and wherein the state component adjusts the state of the user to the active state.
